(19) United States
(12) Patent Application Publication
(10) Pub. No.: US 2013/0134087 A1
(43) Pub. Date: May 30, 2013

(54) Separating apparatus and method

(71) Applicants: Brian E. Porter, Addison, IL (US); Loren W. Semler, Libertyville, IL (US); Wei Chong LI, Guangzhou (CN)

(72) Inventors: Brian E. Porter, Addison, IL (US); Loren W. Semler, Libertyville, IL (US); Wei Chong LI, Guangzhou (CN)

(73) Assignee: SEMLER INDUSTRIES, INC., Franklin Park, IL (US)

(21) Appl. No.: 13/304,632

(22) Filed: Nov. 26, 2011

(51) Int. Cl. B01D 29/00

(52) U.S. Cl. 210/416.1; 210/242.3

(57) ABSTRACT

An apparatus for separating oil and debris from an aqueous fluid disposed in a bath includes a separator assembly including a tank defining an interior chamber, and a separator coupled to the tank, the separator including an inlet in fluid communication with the bath and an outlet. A rotary positive displacement pump has a pump inlet in fluid communication with the separator outlet and a pump outlet in fluid communication with the bath.

### FIELD OF THE DISCLOSURE

The present disclosure generally relates to fluid separation and filtering devices, and more particularly to apparatus and methods for separating floating oil and floating and suspended solids from an aqueous fluid.

### BACKGROUND OF THE DISCLOSURE

Aqueous fluids are used in a variety of applications and for a number of different purposes. For example, aqueous fluids are often used to clean, cool, and suppress bacterial growth in various types of equipment or parts used in machine shops, automotive repair facilities, and other locations. During use, the aqueous fluid may pick up contaminants such as floating oil, sludge, and floating or suspended solids (such as metal shavings), from the equipment and parts. Such contaminants may clog the circulation pump, foster anaerobic or aerobic bacterial growth, and contaminate materials placed in the bath. The contaminants may cause additional problems in certain applications, such as when the aqueous fluid is a machining coolant, since the contaminants may be discharged from the machine tool onto the workpiece. The transfer of contaminants to the workpiece may cause imperfections in the surfaces of the workpiece, reducing the machining quality and increasing the scrap rate.

Various separation and/or filtering apparatus are known for removing oil, sludge, and debris from the aqueous fluid so that the aqueous fluid may be reused. Such apparatus typically draws the aqueous fluid from a reservoir, such as a sump, through a floating skimmer. The oil, sludge, and debris is then removed during various separating and filtering stages, after which clean aqueous fluid is then returned to the reservoir. During the process, the aqueous fluid and contaminants may be pumped into a drum. The aqueous fluid, oil, sludge, and other contaminants have different densities and therefore separate into different layers within the tank, with the oil typically rising to the top of the tank. By drawing aqueous fluid from a bottom of the tank, the oil and other contaminants remain in the tank. Another filter stage may be used to remove debris or other contaminants from the relatively clean aqueous fluid drawn from the tank bottom.

Conventional separation apparatus suffer from several drawbacks. First, the pumps used in typical separation apparatus impose excessive space requirements or introduce performance inefficiencies. Some prior designs include a submersible pump disposed in the sump. This approach requires the sump to be sufficiently large to accommodate the pump and therefore imposes specific space requirements for the system. Additionally, operation of the pump within the sump will agitate the aqueous fluid passing through the pump, thereby more thoroughly mixing the contaminants with the aqueous fluid and making separation more difficult. Other designs that locate the pump outside of the sump impose other space requirements and generally suffer from decreased separation performance. Second, conventional separation apparatus also have clogging problems at the inlet that cause performance and maintenance issues. Third, the location of certain components outside of the barrel in conventional separation apparatus makes them more difficult to ship and service. The subject matter specified in the appended claims may address these and other issues with previously known separation apparatus.

### SUMMARY OF THE DISCLOSURE

In accordance with one aspect of the disclosure, an apparatus for separating oil and debris from an aqueous fluid disposed in a bath is provided that includes a separator assembly including a tank defining an interior chamber, and a separator coupled to the tank, the separator including an inlet in fluid communication with the bath and an outlet. A rotary positive displacement pump has a pump inlet in fluid communication with the separator outlet and a pump outlet in fluid communication with the bath.

In another aspect of the disclosure that may be combined with any of these aspects, the rotary positive displacement pump comprises a rotary vane pump.

In another aspect of the disclosure that may be combined with any of these aspects, the rotary vane pump includes vanes and stators formed of a carbon material.

In another aspect of the disclosure that may be combined with any of these aspects, the rotary vane pump includes vanes and stators having an exterior surface formed of PEEK.

In another aspect of the disclosure that may be combined with any of these aspects, the rotary vane pump comprises one of a magnetic induction drive and a direct drive.

In another aspect of the disclosure that may be combined with any of these aspects, the aqueous fluid comprises a machining coolant.

In another aspect of the disclosure that may be combined with any of these aspects, the separator tube is disposed entirely within the tank.

In another aspect of the disclosure that may be combined with any of these aspects, a discharge valve fluidly communicates with the tank interior chamber at a height associated with an oil layer in the tank.

In another aspect of the disclosure that may be combined with any of these aspects, the filter element comprises a cartridge style filter element.

In another aspect of the disclosure that may be combined with any of these aspects, the filter element comprises a pleated filter having a filter rating of 5 to 50 microns.

In another aspect of the disclosure that may be combined with any of these aspects, an ozone assembly may be provided that includes an ozone inlet in fluid communication with the bath, an ozone outlet in fluid communication with the bath, ozone piping extending from the ozone inlet to the ozone outlet, an ozone generator, and an ozone injector operably coupled between the ozone generator and the ozone piping.

In another aspect of the disclosure that may be combined with any of these aspects, an ozone monitor operably coupled to the bath.

In another aspect of the disclosure that may be combined with any of these aspects, a skimmer assembly may be provided having a skimmer inlet in fluid communication with the bath, wherein the separator fluidly communicates with the skimmer assembly.

In another aspect of the disclosure that may be combined with any of these aspects, the separator includes a separator tube having an inlet branch in fluid communication with the bath, an outlet branch, and a bypass branch extending between the inlet branch and the outlet branch, wherein lower ends of the inlet branch and outlet branch fluidly communicate with the tank interior chamber.

In another aspect of the disclosure that may be combined with any of these aspects, a bleed hole is formed in the inlet branch of the separator tube and a bleed tube disposed within the inlet branch and fluidly communicating with the bleed hole.

In another aspect of the disclosure that may be combined with any of these aspects, a filter assembly may include a filter housing defining a filter inlet in fluid communication with the separator outlet, and a filter outlet fluidly communicating with the pump inlet, and a filter element is disposed in the filter housing.

In another aspect of the disclosure that may be combined with any of these aspects, a vacuum pressure sensor is disposed upstream of the pump and configured to generate a signal when a pressure level reaches a predetermined pressure limit, and an operator alert is operatively coupled to the vacuum pressure sensor and configured to illuminate in response to the signal.

In another aspect of the disclosure that may be combined with any of these aspects, a separator assembly is provided for use in apparatus for separating and debris from an aqueous fluid disposed in a bath, the separator apparatus including a tank having a bottom wall and a sidewall extending upwardly from the bottom wall and defining a tank upper end, the tank defining an interior chamber, a lid sealingly coupled to the tank upper end, and a tank inlet tube in fluid communication with the bath. A separator tube is disposed in the tank interior chamber and includes an inlet branch in fluid communication with the tank inlet tube, an outlet branch, and a bypass branch extending between the inlet branch and the outlet branch, wherein lower ends of the inlet branch and outlet branch are disposed near a bottom end of the tank. A tank outlet tube fluid communicates with the separator tube outlet branch, and a weir is disposed in a bottom of the tank interior chamber to define a weir chamber located in a bottom of the tank, wherein the lower end of the separator tube outlet branch is disposed in the weir chamber.

In another aspect of the disclosure that may be combined with any of these aspects, the weir is attached to and extends upwardly from the tank bottom wall.

In another aspect of the disclosure that may be combined with any of these aspects, the weir is attached to the separator tube outlet branch.

In another aspect of the disclosure that may be combined with any of these aspects, both the tank inlet tube and the tank outlet tube extend through the tank side wall.

In another aspect of the disclosure that may be combined with any of these aspects, both the tank inlet tube and the tank outlet tube extend through the lid.

In another aspect of the disclosure that may be combined with any of these aspects, the separator tube is spaced from a centerline of the tank.

In another aspect of the disclosure that may be combined with any of these aspects, the separator tube inlet branch extends along an inlet branch centerline, the tank inlet tube includes a discharge opening disposed around an inlet tube centerline, and the inlet tube centerline is offset from the inlet branch centerline.

In another aspect of the disclosure that may be combined with any of these aspects, an air permeable foam breaker disposed in each of the inlet and outlet branches.

In another aspect of the disclosure that may be combined with any of these aspects, a tether is coupled to the air permeable foam breakers.

In another aspect of the disclosure that may be combined with any of these aspects, a skimmer assembly is provided for use in apparatus for separating and debris from an aqueous fluid disposed in a bath, the skimmer assembly including a suction hose defining an intake end, a float sleeve disposed around at least a portion of the suction hose, a skimmer body coupled to the suction hose intake end, the skimmer body defining a skimmer inlet opening, and a single float coupled to the skimmer body.

In another aspect of the disclosure that may be combined with any of these aspects, the skimmer body defines a body bottom wall having two opposing longitudinal edges and two opposing lateral edge, a body end wall extending upwardly from one of the longitudinal edges of the body bottom wall, two body side walls extending upwardly from respective lateral edges of the body bottom wall, and an inlet wall extending upwardly from a remaining one of the longitudinal edges of the body bottom wall, wherein the inlet wall extends partially toward a top edge of the body side walls so that the skimmer inlet opening is defined by the body inlet wall and an open top of the body.

In another aspect of the disclosure that may be combined with any of these aspects, the body inlet wall includes a central portion defining a linear central edge disposed at a first height above the body bottom wall, and two lateral portions defining linear lateral edges that extend from the central edge at the first height to terminal edges disposed at a second height above the body bottom wall, wherein the second height is greater than the first height.

### BRIEF DESCRIPTION OF THE DRAWINGS

FIG. 1 is a schematic perspective view of a separating apparatus constructed according to the present disclosure;

FIG. 2 is a schematic, perspective, exploded view of the separating apparatus of FIG. 1;

FIG. 3 is a schematic perspective view of a skimmer assembly used in the separating apparatus of FIG. 1;

FIG. 4 is an enlarged, perspective view of a skimmer body used in the skimmer assembly of FIG. 3;

FIG. 5 is a side elevation view of a separating assembly used in the separating apparatus of FIG. 1;

FIG. 6 is a top view of the separating assembly of FIG. 5;

FIG. 7 is an enlarged perspective view of a separating tube used in the separating assembly of FIG. 5;

FIG. 8 is an exploded, schematic perspective view of a filter assembly used in the separating apparatus of FIG. 1;

FIG. 9 is an exploded, schematic perspective view of an ozone assembly used in the separating apparatus of FIG. 1;

FIG. 10 is a schematic side elevation view of an alternative embodiment having inlet and outlet tubes extending through a tank lid instead of a tank side wall; and

FIG. 11 is a schematic, rear perspective view of an enclosure for some of the components used in the separating apparatus of FIG. 1.

While the present disclosure is susceptible to various modifications and alternative constructions, certain illustrative embodiments thereof have been shown in the drawings and will be described below in detail. It should be understood, however, that there is no intention to be limited to the specific forms disclosed, but on the contrary, the intention is to cover all modifications, alternative constructions, and equivalents falling within the spirit and scope of the present disclosure.

### DETAILED DESCRIPTION

Exemplary embodiments of separating apparatus are disclosed herein for efficiently separating oil, floating solids, and suspended solids from an aqueous, or water-based, fluid. The aqueous fluid may be a solvent-type fluid such as a machining coolant, which may be synthetic, semi-synthetic, or soluble oil. The aqueous fluid is held in a bath. As used herein, the term “bath” is used to indicate the structure in which the aqueous fluid is collected during operation of the on-site equipment that uses the fluid, and may also be identified in the industry as a tank, a reservoir, a sump, a tub, or other equivalent term. The separating apparatus draws the fluid from the bath, separates oil, debris, and other contaminants from the aqueous fluid in stages, and returns the fluid to the bath. Various features discussed in greater detail below reduce the space requirements required for the apparatus, improve separation efficiency, and generally improve performance of the apparatus as compared to the previously known conventional designs.

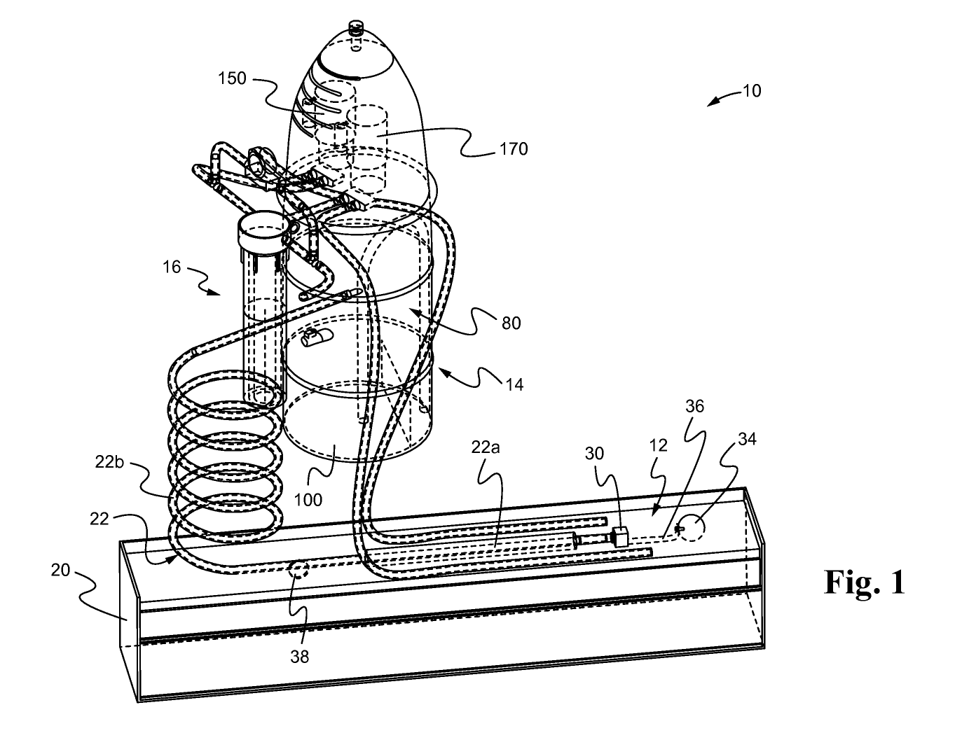

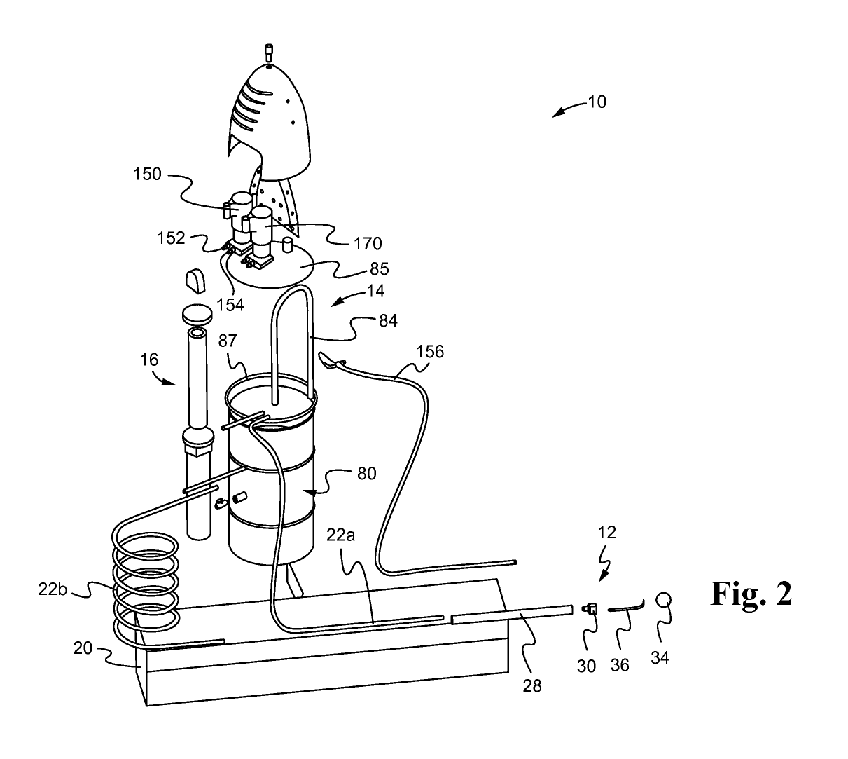

An exemplary embodiment of a separating apparatus 10 is shown in FIGS. 1 and 2. In the illustrated embodiment, the separating apparatus 10 generally includes a skimmer assembly 12, a separator assembly 14, and a filter assembly 16. In operation, the skimmer assembly 12 fluidly communicates with a bath 20 holding aqueous fluid with contaminants. The bath 20 may be a tank, reservoir, sump, tub, or other structure suitable for holding the aqueous fluid. The aqueous fluid is pulled through the separator assembly 14 and filter assembly 16 which remove at least some of the contaminants from the fluid, and relatively clean aqueous fluid is then returned to the bath 20.

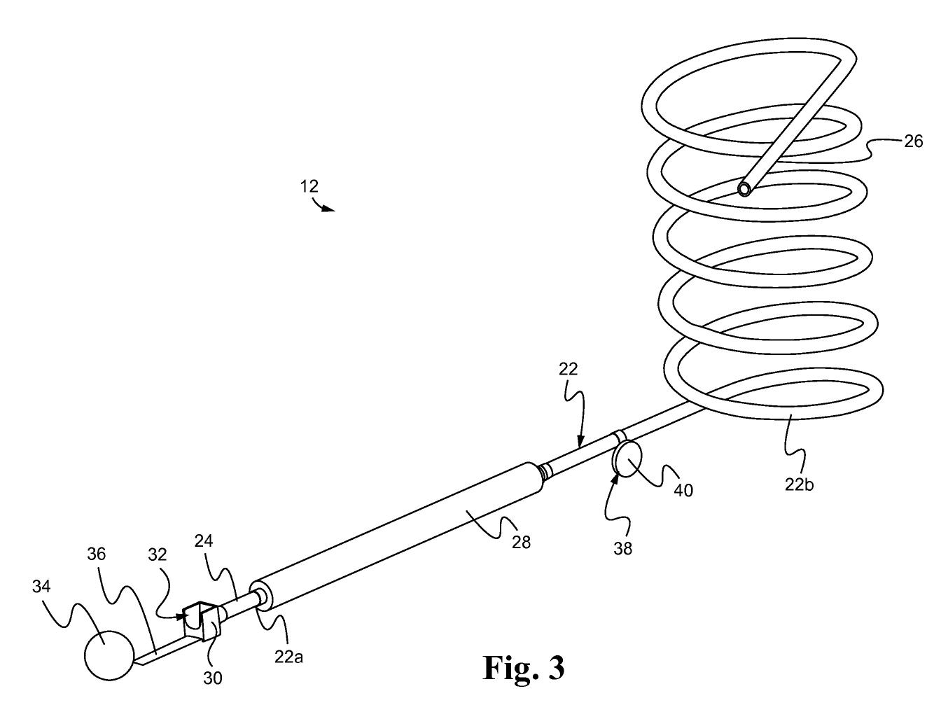

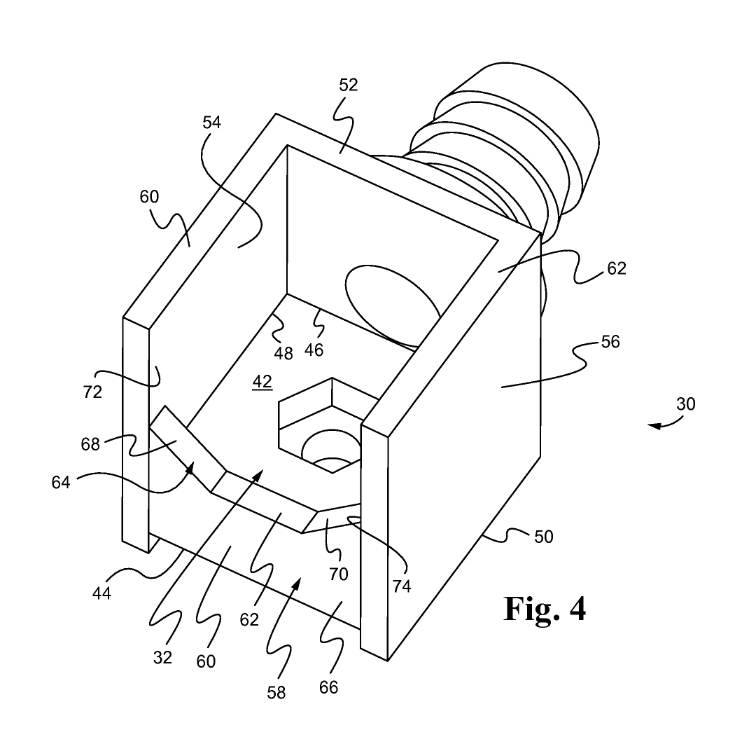

The skimmer assembly 12 is shown in greater detail in FIGS. 3 and 4. The skimmer assembly 12 includes a suction hose 22 having an intake end 24 and a discharge end 26. In the illustrated embodiment, the suction hose 22 comprises a flexible hose segment 22a disposed inside the bath 20 and a durable hose segment 22b generally disposed outside of the bath 20. A float sleeve 28 is coupled to a portion of the suction hose 22 that is disposed in the bath 20. The float sleeve 28 has a density that is sufficiently low so that it is buoyant in the aqueous fluid, thereby holding the suction hose 22 near a surface of the aqueous fluid disposed in the bath 20. A skimmer body 30 is coupled to the intake end 24 of the suction hose 22 to define a skimmer inlet opening 32. A float 34 is coupled to the skimmer body 30 by a bracket 36. The float 34 may have a ball, flat, or other shape. A clamp 38 may be coupled to the suction hose 22 and is adapted for attachment to an inside surface of the bath 20. In an exemplary embodiment, the clamp 38 includes a magnetic base 40 that magnetically engages the bath 20.

The skimmer body 30 and inlet opening 32 may be configured to minimize clogging from debris. As best shown in FIG. 4, the skimmer body 30 includes a body bottom wall 42 having front and rear longitudinal edges 44, 46, and two opposing lateral edges 48, 50. A body end wall 52 extends upwardly from the rear longitudinal edge 46 and two body side walls 54, 56 extend upwardly from respective lateral edges 48, 50 of the body bottom wall 42. An inlet wall 58 extends upwardly from the front longitudinal edge 44 of the body bottom wall 42. The inlet wall 58 may extend only partially toward top edges 60, 62 of the body side walls 54, 56, so that the skimmer inlet opening 32 is defined by the body inlet wall 58 and an open top of the body 30. The body inlet wall 58 may include a central portion 60 defining a linear central edge 62 disposed at a first height above the body bottom wall 42 and two lateral portions 64, 66 defining linear lateral edges 68, 70 that extend from the central edge 62 at the first height to terminal edges 72, 74 disposed at a second height above the body bottom wall 42, wherein the second height is greater than the first height. During operation, the aqueous fluid will have a higher flow velocity over the lateral edges 68, 70 and terminal edges 72, 74, thereby reducing the amount of debris that may clog the inlet opening 32.

The separator assembly 14 is best shown in FIGS. 1-2 and 5-7. The separator assembly 14 includes a tank 80 defining an interior chamber 82 and a separator tube 84 disposed in the tank 80. In the illustrated embodiment, the separator tube 84 has a generally inverted-U shape that includes an inlet branch 86 and an outlet branch 88 fluidly coupled by a bypass branch 90. An inlet tube 92 extends substantially horizontally from the inlet branch 86 and is adapted for fluid coupling with the discharge end 26 of the suction hose 22. An outlet tube 94 extends from the outlet branch 88 and may also extend substantially horizontally. Alternatively, the inlet tube 92 and outlet tube 94 may be oriented at downward angles toward the separator tube 84 so that fluid would drain from the inlet and outlet tubes 92, 94 and into the separator tube 84 when the system is not running.

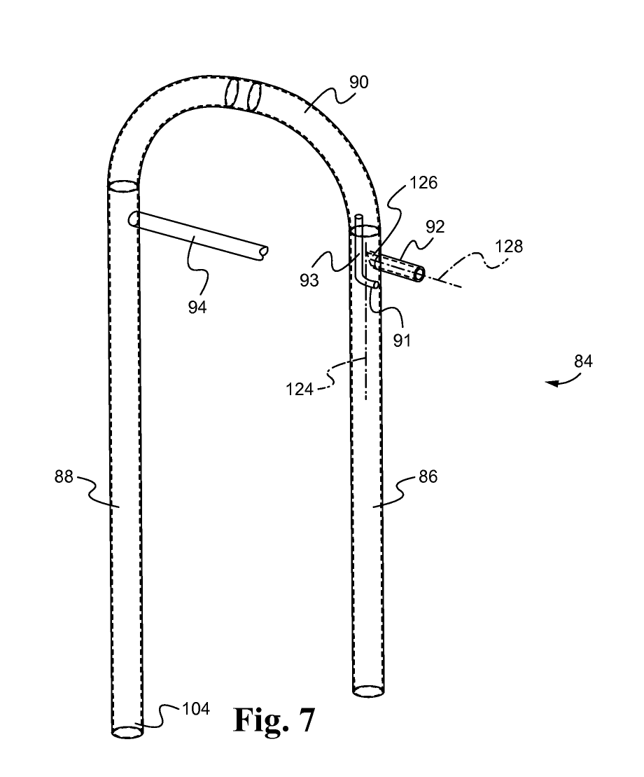

A bleed hole 91 may extend through the inlet branch 86 to permit air from the tank interior chamber 82 to flow into the separator tube 84, as best shown in FIG. 7. A bleed tube 93 may fluidly communicate with the bleed hole 91 and extend vertically upwardly with the inlet branch 86 and past the inlet tube 92 to minimize oxidation of the aqueous fluid.

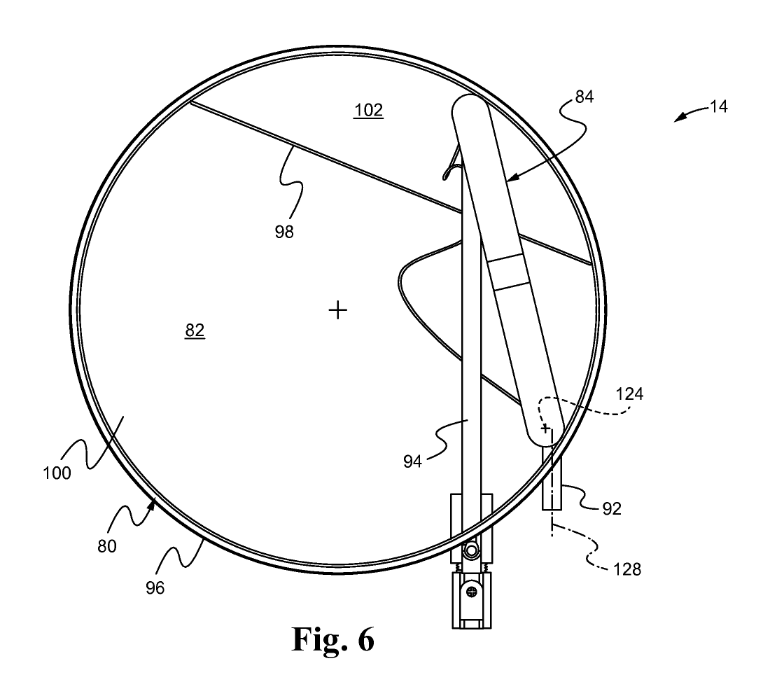

A weir 98 may extend upwardly from a bottom wall 100 of the tank 80 to define a weir chamber 102 located in a bottom of the tank (FIG. 6). A lower end 104 of the separator tube outlet branch 88 may be disposed in the weir chamber 102, so that aqueous fluid drawn through the outlet branch 88 will have less debris entrained therein due to the weir 98. In the illustrated embodiment, the entire separator tube 84 is disposed inside the interior chamber 82 of the tank 80 to provide a self-contained assembly. The separator tube 84 may be advantageously positioned off-center within the tank 80, as best shown in FIG. 6, to facilitate access to the tank interior chamber 82 for inspection, maintenance, or other purposes. A lid 85 is coupled to the tank 80 by a bolt ring 87. The lid 85 may include an integral gasket that forms an air tight seal with the tank 80.

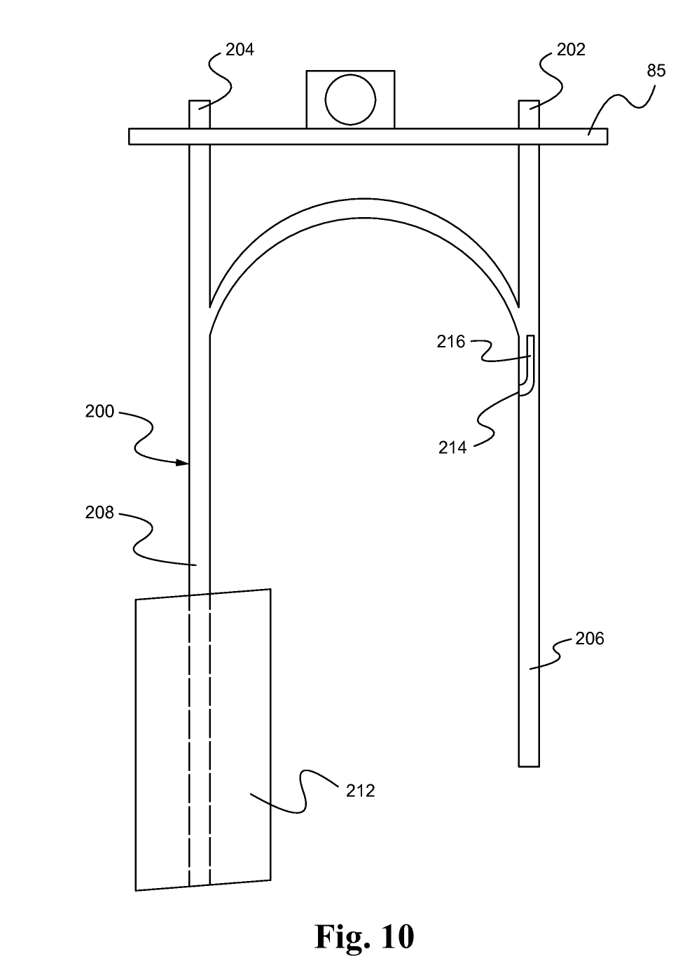

The inlet and outlet tubes 92, 94 may extend through a side wall 96 of the tank 80 as shown, or may be configured in a manner that does not require modification of the tank side wall 94. For example, in the alternative embodiment illustrated in FIG. 10, a modified separator tube 200 may be coupled to the lid 85. In the exemplary embodiment, an inlet tube 202 and an outlet tube 204 are coupled to and extend through the lid 85. The separator tube 200 includes an inlet branch 206, outlet branch 208, and bypass branch 210, similar to the separator tube 84 described above. A weir 212 may be coupled to the outlet branch 208 so that it may be removed with the separator tube 200. The separator tube 200 may further include a bleed port 214 and bleed tube 216. Accordingly, the fluid connections to the separator tube 200 do not require modifications to the tank, and the separator tube 200 and weir 212 may be removed integrally with the lid 85.

In operation, aqueous fluid from the suction hose 22 is discharged into the inlet branch 86 of the separator tube 84. The fluid and contaminants will then travel down the inlet branch 86 to collect in the interior chamber 82 of the tank 80. As the fluid collects inside the tank 80, it will separate into layers based on the density of the constituent fluid components. More specifically, the fluid will separate inside the tank 80 into an air layer 110 at the top, an oil layer 112 below the air layer 110, an oil emulsion layer 114 below the oil layer 112, an aqueous fluid layer 116 below the emulsion layer 114, and a solids layer 118 below the aqueous fluid layer 116. Solids collecting in the solids layer 118 are generally prevented by the weir 98 from entering the weir chamber 102. Additionally, the lower end 104 of the separator tube outlet branch 88 is positioned so that it is located within the aqueous fluid layer 116, so that fluid traveling up the outlet branch 88 is relatively free of debris and oil.

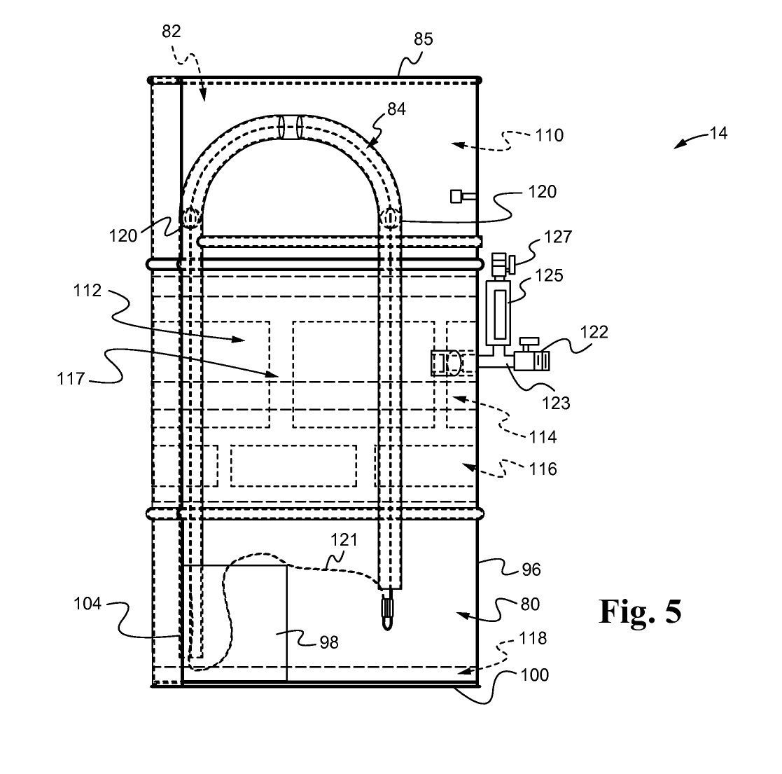

To further assist with the separation between the oil and oil emulsion layers 112, 114 on the one hand and the aqueous fluid layer 116 on the other hand, an optional oleophilic packing material 117 may be provided inside the tank 80. In the exemplary embodiment illustrated in FIG. 5, the oleophilic packing material 117 may be provided in the form of raschig or pall rings made of polypropylene, polyvinylidene fluoride (PVDF) or similar material.

Air permeable foam breakers 120 may be inserted into the separator tube 84 to reduce the amount of foam exiting the tank 80. The foam breakers 120 may be formed of stainless steel wool or other suitable material that retains or minimizes foam while permitting air or other fluid to pass. The foam breakers 120 may be attached to a tether 121 to permit removal for cleaning the separator tube 84. A discharge valve 122 may extend through the tank side wall 94 at a height commensurate with the oil layer 112 and may be manually operable to drain a portion of the separated oil from the tank 80. In the embodiment illustrated in FIG. 5, the discharge valve 122 is coupled to one branch of a T-connection 123. The other branch of the T-connection 123 is coupled to a sight gauge 125 which permits the user to observe an oil level in the tank 80. An air relief valve 125 is coupled to an opposite end of the site gauge 125 to permit air to be released from the site gauge 125, so that the oil level may be more accurately displayed by the site gauge 125.

Air that may be been pulled through the suction hose 22 may pass through the bypass branch 90 directly to the outlet branch 88. The inlet tube 92 may be configured to promote a spiral flow as the fluid enters the inlet branch 86, thereby reducing foam and promoting separation of air from the aqueous fluid. As best shown in FIGS. 6 and 7, the separator tube inlet branch 86 extends along an inlet branch centerline 124 and the inlet tube 92 includes a discharge opening 126 disposed around an inlet tube discharge centerline 128. The inlet tube discharge centerline 128 is laterally offset from the inlet branch centerline 124 to impart a swirling or spiral shape to the fluid flow as it enters the inlet branch 86. Additionally, the inlet tube 92 may be tapered to have a reducing diameter as it enters the inlet branch 86, thereby to further reduce splashing and foam generation.

The filter assembly 16 is configured to receive aqueous fluid from the separator assembly 14 and remove suspended solids from the fluid. As best shown in FIGS. 1, 2, and 8, the filter assembly 16 includes a filter housing 130 coupled to a filter base 132 defining a filter inlet 134 in fluid communication with the outlet branch 88 and a filter outlet 136. A filter element 138, such as a cartridge style, pleated polyester filter having a 5 to 50 micron filter size, is disposed inside the filter housing 130. The filter element 138 removes suspended solids from the aqueous fluid. The filter assembly 16 may further include a pressure bypass line 140 and a differential pressure gauge 142 disposed in the pressure bypass line 140 for providing feedback on the state of the filter element 138.

A pump 150 is provided for circulating the aqueous fluid through the separating apparatus 10. The pump 150 includes a pump inlet 152 in fluid communication with the filter outlet 136 and a pump outlet 154 that fluidly communicates with the bath 20 through a return hose 156. The pump 150 is located outside of the bath 20 and may be a rotary positive displacement pump, such as a rotary vane pump, a rotary gear pump, or a rotary hose/peristaltic pump. The pump 150 may have vanes and stators made of carbon or other material having advantageous heat-resistant characteristics. Additionally or alternatively, the vanes and stators of the pump may be coated with or formed of PEEK. In certain embodiments, the pump has a magnetic induction drive to further reduce contact between moving parts and improve pump life. Accordingly, a pump that is particularly suited for use in a separating assembly may be a rotary vane style to provide positive displacement of both liquid and air, has moving parts formed of relatively soft materials to reduce friction, and has vanes and stators formed of a material having high heat tolerance such as carbon. Still further, in applications where the fluid is a coolant, the coolant itself will further help reduce friction and heat generation, thereby further improving pump performance.

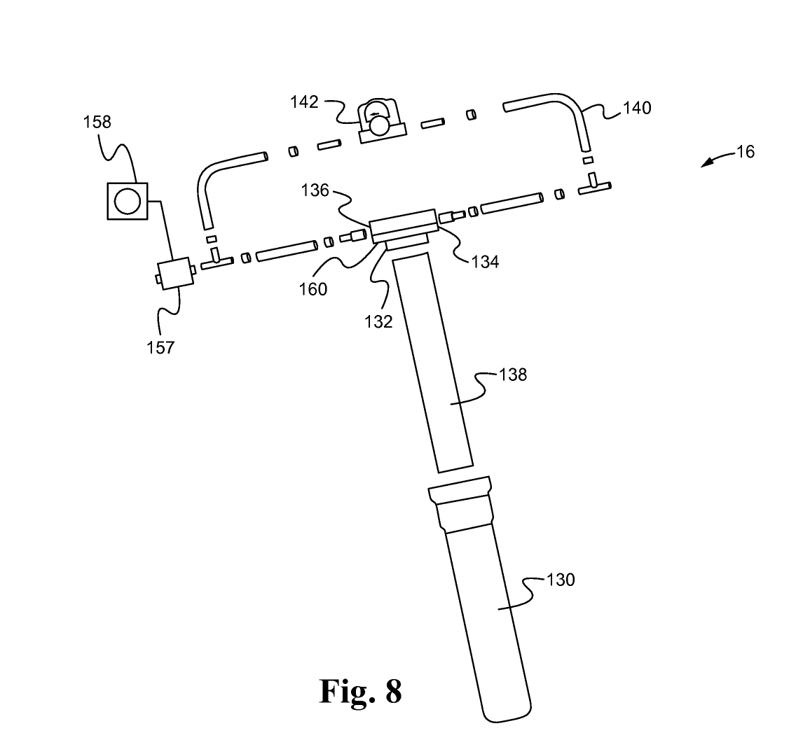

A vacuum pressure monitor may be provided to inform the use of a possible need to replace the filter element 138 or of a possible clog in the system. In an exemplary embodiment, the vacuum pressure monitor may include a vacuum switch 157 disposed in the system piping, such as downstream of the filter assembly 16 (FIG. 8). The vacuum switch 157 may be configured to change states or otherwise generates a signal when the pressure in the system piping reaches a pressure limit. An operator alert, such as alert light 158, may be operatively coupled to the vacuum switch 157 and configured to illuminate when the vacuum switch 157 signals that the pressure limit has been reached or exceeded. The pressure limit may be selected so that it corresponds to an obstruction in the system, such as a clogged filter or plugged hose, tube, or piping in the system. Accordingly, when the alert light 158 is illuminated, the user is notified that the system may require maintenance.

A vacuum relief valve 160 may be provided to prevent damage to the pump 150 or tank 80. In the illustrated embodiment, the vacuum relief valve 160 is formed in the filter base 132. The vacuum relief valve 160 may be located on the outlet side of the filter assembly 16 to protect all of the components of the separating apparatus 10, or on the inlet side of the filter assembly 16 to allow a higher vacuum across the filter element 138 and to increase filter element life. The vacuum relief valve 160 may be adjustable to permit varying degrees of vacuum depending on the rating of the filter element 138 and/or pump 150. The vacuum relief valve 160 will automatically open in response to excessive vacuum due to clogging of the filter element 138, skimmer body inlet opening 32, suction hose 22, or other component in the system. The vacuum relief valve 160 is a mechanical relief valve that may be provided as a substitute for, or in addition to, the vacuum pressure monitor noted above.

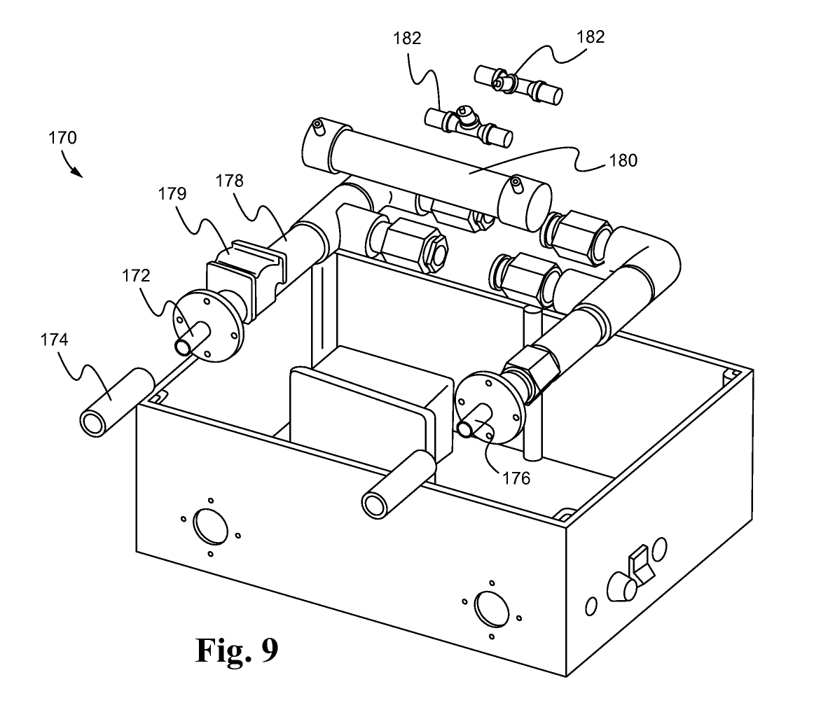

An optional ozone assembly 170 may be provided for treating the aqueous fluid to prevent bacteria or other biological growth. As best shown in FIG. 9, the ozone assembly 170 may include an inlet 172 in fluid communication with the bath 20 through an ozone suction hose 174. An ozone outlet 176 is in fluid communication with the bath 20, such as through a connection with the return hose 156. Ozone piping 178 extends from the ozone inlet 172 to the ozone outlet 176. An ozone pressure switch 179 is disposed in the piping 178 near the inlet 172 to activate power to the ozone assembly when the pump 150 is operating. A pair of ozone generators 180 (only 1 shown in FIG. 9) is provided in the ozone piping 178. Each ozone generator 180 has two ozone injectors 182 operably coupled between the ozone generator 180 and the ozone piping 178. The ozone assembly 170 may further include an ozone monitor operably coupled to the bath 20.

By providing multiple ozone generators 180 with multiple ozone injectors 182, the ozone assembly 170 permits adjustable ozone production and more reliable operation. The operator may choose how many generators 180 to run at a given time, thereby permitting adjustment of the amount of ozone generated. While two generators 180 are shown in the illustrated embodiment, more than two generators 180 are also contemplated. Additionally, with multiple generators 180, ozone is more reliably generated in the event a generator is disabled, as the other generator(s) will continue to operate. The use of multiple injectors 182 allows smaller ozone bubbles to be injected into the fluid stream that dissolve more quickly and increase the ozone content in the fluid. Also, the system will continue to operate even when an injector 182 is clogged.

The ozone monitor may detect a level of dissolved ozone or millivolts of oxidation reduction potential (ORP) in the aqueous fluid held in the bath 20. The ozone assembly 170 may be controlled to prevent diffusion of excessive ozone into the bath 20, which would waste energy and potentially damage the components of the separating apparatus 10. The ozone monitor may measure ozone levels (by measuring millivolts ORP, quantity of dissolved ozone, or other method) at an outlet stream once the ozone level has stabilized, which indicates the ozone level above which the ozone is excessive. The ozone monitor can then provide an ozone reading that indicates whether the contents of the bath 20 have been adequately sanitized.

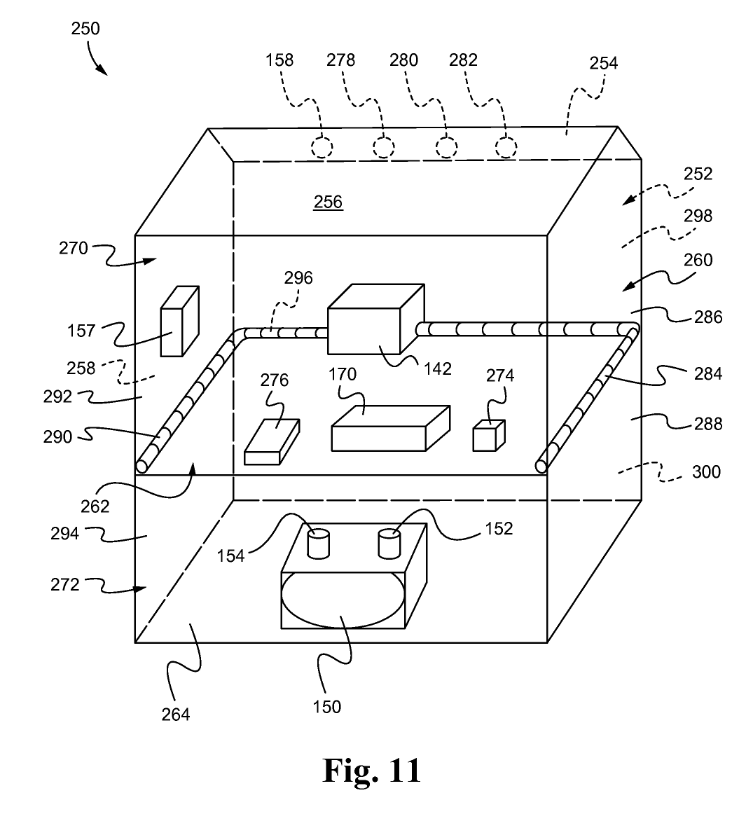

FIG. 11 illustrates an enclosure 250 that may house various components of the separating apparatus 10. The enclosure 250 includes a front wall 252, two side walls 258, 260, a rear wall 262 with integral control panel wall 254 and top wall 256, and a bottom wall 264. A sub-panel 266 divides an interior enclosure space into upper and lower enclosure spaces 270, 272. The lower enclosure space 272 may house the pump 150, while the upper enclosure space 270 may house the vacuum switch 157, the differential pressure gauge 142, and the ozone assembly 170. Additional components may be housed in the upper enclosure space 270, such as a relay 274, a timer 276, and other electrical components used to operate the apparatus 10. Various lights and buttons may be coupled to the control panel wall 256, such as the vacuum alert light 158, a power indication light 278, a reset switch 280, and an on/off switch 282.

To facilitate access to the interior enclosure space, at least some of the walls of the enclosure 250 may be hinged. For example, a hinge 284 may be provided in side wall 260 so that a top panel 286 may be rotated away from the interior enclosure space and toward a bottom panel 288. Similarly, a hinge 290 is provided in side wall 262 to permit a top panel 292 to rotate toward a bottom panel 294. Still further, a hinge 296 may be provided in front wall 252 that permits a top panel 298 to rotate toward a bottom panel 300. Then the top panels 286, 292, 298 are rotated outwardly, the interior enclosure space is more easily accessible.

The inlet hose 22, return hose 156, tank 80, and other components may be made of a material that is compatible not only with the aqueous fluid but also the oil and other contaminants, and may also be abrasion resistant to handle the passing of solids entrained in the fluid. The selected material may also be compatible with anti-bacterial, anti-fungal, or anti-microbial elements such as chlorine or ozone. The separator tube 84 may be formed of a material that resists rust, chemical reaction with the aqueous fluids and contaminants, and can withstand the vacuum pressure. Suitable material includes stainless steel (such as stainless steel 304 or other grades), mild steel, and plastic.

While only certain embodiments have been set forth, alternatives and modifications will be apparent from the above description to those skilled in the art.

These and other alternatives are considered equivalents and within the spirit and scope of this disclosure.

What is claimed is:

1. Apparatus for separating oil and debris from an aqueous fluid disposed in a bath, the apparatus comprising:
a separator assembly including a tank defining an interior chamber, and a separator coupled to the tank, the separator including an inlet in fluid communication with the bath and an outlet; and
a rotary positive displacement pump having a pump inlet in fluid communication with the separator outlet and a pump outlet in fluid communication with the bath.

2. The apparatus of claim 1, in which the rotary positive displacement pump comprises a rotary vane pump.

3. The apparatus of claim 2, in which the rotary vane pump includes vanes and stators formed of a carbon material.

4. The apparatus of claim 2, in which the rotary vane pump includes vanes and stators having an exterior surface formed of PEEK.

5. The apparatus of claim 1, in which the rotary vane pump comprises one of a magnetic induction drive and a direct drive.

6. The apparatus of claim 1, in which the aqueous fluid comprises a machining coolant.

7. The apparatus of claim 1, in which the separator tube is disposed entirely within the tank.

8. The apparatus of claim 1, further comprising discharge valve fluidly communicating with the tank interior chamber at a height associated with an oil layer in the tank.

9. The apparatus of claim 1, in which the filter element comprises a cartridge style filter element.

10. The apparatus of claim 1, in which the filter element comprises a pleated filter having a filter rating of 5 to 50 microns.

11. The apparatus of claim 1, further comprising an ozone assembly including:
an ozone inlet in fluid communication with the bath;
an ozone outlet in fluid communication with the bath;
ozone piping extending from the ozone inlet to the ozone outlet;
an ozone generator; and
an ozone injector operably coupled between the ozone generator and the ozone piping.

12. The apparatus of claim 11, further comprising an ozone monitor operably coupled to the bath.

13. The apparatus of claim 1, further comprising a skimmer assembly having a skimmer inlet in fluid communication with the bath, wherein the separator fluidly communicates with the skimmer assembly.

14. The apparatus of claim 1, in which the separator comprises a separator tube having an inlet branch in fluid communication with the bath, an outlet branch, and a bypass branch extending between the inlet branch and the outlet branch, wherein lower ends of the inlet branch and outlet branch fluidly communicate with the tank interior chamber.

15. The apparatus of claim 14, further comprising a bleed hole formed in the inlet branch of the separator tube and a bleed tube disposed within the inlet branch and fluidly communicating with the bleed hole.

16. The apparatus of claim 1, further comprising a filter assembly including:
a filter housing defining a filter inlet in fluid communication with the separator outlet, and a filter outlet fluidly communicating with the pump inlet; and
a filter element disposed in the filter housing.

17. The apparatus of claim 1, further comprising a vacuum pressure sensor disposed upstream of the pump and configured to generate a signal when a pressure level reaches a predetermined pressure limit, and an operator alert operatively coupled to the vacuum pressure sensor and configured to illuminate in response to the signal.

18. A separator assembly for use in apparatus for separating and debris from an aqueous fluid disposed in a bath, the separator apparatus comprising:
a tank having a bottom wall and a sidewall extending upwardly from the bottom wall and defining a tank upper end, the tank defining an interior chamber;
a lid sealingly coupled to the tank upper end;
a tank inlet tube in fluid communication with the bath;
a separator tube disposed in the tank interior chamber and including an inlet branch in fluid communication with the tank inlet tube, an outlet branch, and a bypass branch extending between the inlet branch and the outlet branch, wherein lower ends of the inlet branch and outlet branch are disposed near a bottom end of the tank;
a tank outlet tube in fluid communication with the separator tube outlet branch; and
a weir disposed in a bottom of the tank interior chamber to define a weir chamber located in a bottom of the tank, wherein the lower end of the separator tube outlet branch is disposed in the weir chamber.

19. The separator assembly of claim 18, in which the weir is attached to and extends upwardly from the tank bottom wall.

20. The separator assembly of claim 18, in which the weir is attached to the separator tube outlet branch.

21. The separator assembly of claim 18, in which both the tank inlet tube and the tank outlet tube extend through the tank side wall.

22. The separator assembly of claim 18, in which both the tank inlet tube and the tank outlet tube extend through the lid.

23. The separator assembly of claim 18, in which the separator tube is spaced from a centerline of the tank.

24. The separator assembly of claim 18, in which the separator tube inlet branch extends along an inlet branch centerline, in which the tank inlet tube includes a discharge opening disposed around an inlet tube centerline, and in which the inlet tube centerline is offset from the inlet branch centerline.

25. The separator assembly of claim 18, further comprising an air permeable foam breaker disposed in each of the inlet and outlet branches.

26. The separator assembly of claim 25, further comprising a tether coupled to the air permeable foam breakers.

27. A skimmer assembly for use in apparatus for separating and debris from an aqueous fluid disposed in a bath, the skimmer assembly comprising:
a suction hose defining an intake end;
a float sleeve disposed around at least a portion of the suction hose;
a skimmer body coupled to the suction hose intake end, the skimmer body defining a skimmer inlet opening; and
a single float coupled to the skimmer body.

28. The skimmer assembly of claim 27, in which the skimmer body defines a body bottom wall having two opposing longitudinal edges and two opposing lateral edge, a body end wall extending upwardly from one of the longitudinal edges of the body bottom wall, two body side walls extending upwardly from respective lateral edges of the body bottom wall, and an inlet wall extending upwardly from a remaining one of the longitudinal edges of the body bottom wall, wherein the inlet wall extends partially toward a top edge of the body side walls so that the skimmer inlet opening is defined by the body inlet wall and an open top of the body.

29. The skimmer assembly of claim 28, in which the body inlet wall includes a central portion defining a linear central edge disposed at a first height above the body bottom wall, and two lateral portions defining linear lateral edges that extend from the central edge at the first height to terminal edges disposed at a second height above the body bottom wall, wherein the second height is greater than the first height.
